(19) United States
(12) Patent Application Publication
(10) Pub. No.: US 2025/0309362 A1
(43) Pub. Date: Oct. 2, 2025

(54) SOLID-STATE BATTERY AND METHOD FOR MANUFACTURING SOLID-STATE BATTERY

(71) Applicant: HONDA MOTOR CO., LTD., Tokyo (JP)

(72) Inventors: Seiichiro ISHIKAWA, Saitama (JP); Yoshihiko NAKAJIMA, Saitama (JP); Akihiro TAGUCHI, Saitama (JP)

(21) Appl. No.: 19/064,630

(22) Filed: Feb. 26, 2025

(30) Foreign Application Priority Data
Mar. 30, 2024 (JP) 2024-058320

(51) Int. Cl. H01M 10/0585; H01M 50/46; H01M 50/463

(52) U.S. Cl. CPC H01M 10/0585; H01M 50/46; H01M 50/463

(57) ABSTRACT

A solid-state battery includes a positive electrode current collector, a positive electrode material layer, a predetermined solid electrolyte layer, a negative electrode side solid electrolyte layer, and a negative electrode in this order towards at least one side in a lamination direction. An insulating positive electrode frame is provided so as to surround the positive electrode material layer. Hereinafter, the area of a portion inside the outer edge of the positive electrode frame is defined as “sF”, the area of the predetermined solid electrolyte layer is defined as “sEc”, the area of the negative electrode side solid electrolyte layer is defined as “sEn”, and the area of the negative electrode is defined as “sN”. The solid-state battery satisfies a relationship “sF≥sEc sN≥sEn”. An insulating member is attached to a surface, on the positive electrode current collector side, of the negative electrode tab.

This application is based on and claims the benefit of priority from Japanese Patent Application No. 2024-058320, filed on 30 Mar. 2024, the content of which is incorporated herein by reference.

### BACKGROUND OF THE INVENTION

### Field of the Invention

The present invention relates to a solid-state battery mounted on, for example, a vehicle.

### Related Art

In recent years, electric vehicles such as EVs or HEVs have become increasingly popular from the perspective of, for example, reducing adverse effects on the global environment by reducing carbon dioxide emissions. Secondary batteries mounted on, for example, electric vehicles include the following solid-state battery.

The solid-state battery includes a positive electrode current collector, and in the order from the positive electrode current collector to each side in a lamination direction, includes a positive electrode material layer, a solid electrolyte layer, and a negative electrode. An insulating positive electrode frame is provided closer to the negative electrode than the positive electrode current collector so as to surround the positive electrode material layer. The positive electrode current collector and the positive electrode material layer form a positive electrode. The solid-state battery further includes a positive electrode tab protruding from the positive electrode current collector and a negative electrode tab protruding from the negative electrode.

This solid-state battery is stored in a state of being pressed inward in the lamination direction such that the layers adjacent to each other in the lamination direction are in close contact with each other. Thus, upon use, the solid-state battery is in such a state that the positive electrode is constantly pressed to the negative electrode side and the negative electrode is constantly pressed to the positive electrode side.
Patent Document 1: Japanese Unexamined Patent Application, Publication No. 2023-148244

### SUMMARY OF THE INVENTION

The present inventor(s) have focused on the following problems of such a solid-state battery.

Many of these solid-state batteries increase in a negative electrode volume due to, for example, adsorption of lithium when charged, and decrease in a negative electrode volume due to, for example, desorption of lithium when discharged. Due to the increase/decrease in the negative electrode volume, short-circuit may be caused between the negative electrode tab and the positive electrode current collector. For this reason, an insulation distance between the negative electrode tab and the positive electrode current collector is preferably as long as possible.

In a case where the area of the solid electrolyte layer is increased such that the solid electrolyte layer protrudes in a protruding direction of the negative electrode tab and the insulation distance between the negative electrode tab and the positive electrode current collector is ensured accordingly, the following problem may be caused.

That is, when each layer of the solid-state battery is pressed inward in the lamination direction in a process of manufacturing the solid-state battery, an outwardly-protruding portion of the solid electrolyte layer may be damaged. Particularly, such damage is more likely to be caused in a case where the solid-state battery is manufactured by roll pressing.

The present invention has been made in view of the above-described situation, and an object thereof is to easily ensure a long insulation distance between a negative electrode tab and a positive electrode current collector while reducing the susceptibility of a solid electrolyte layer to damage.

The present inventor(s) have found that the above-described object can be achieved when the area of each layer forming the secondary battery is adjusted to a predetermined size relationship and an insulating member is bonded to a surface, on the positive electrode side, of the negative electrode tab, and as a result, have arrived at the present invention. The present invention relates to a solid-state battery according to (1) to (6) below and a method for manufacturing a solid-state battery according to (7) below.

(1) A solid-state battery includes a positive electrode current collector, a positive electrode material layer, a predetermined solid electrolyte layer, a negative electrode side solid electrolyte layer, and a negative electrode in this order towards at least one side in a lamination direction, a positive electrode tab protruding from the positive electrode current collector, and a negative electrode tab protruding from the negative electrode,
an insulating positive electrode frame is provided closer to the negative electrode than the positive electrode current collector so as to surround the positive electrode material layer,
the volume of the negative electrode increases by charging, and decreases by discharging,
when the area of a portion inside the outer edge of the positive electrode frame in a plan view in the lamination direction is defined as “sF”, the area of the predetermined solid electrolyte layer in the plan view is defined as “sEc”, the area of the negative electrode side solid electrolyte layer in the plan view is defined as “sEn”, and the area of the negative electrode in the plan view is defined as “sN”, a relationship “sF≥sEc≥sN≥sEn” is satisfied, and an insulating member is attached to a surface, on the positive electrode current collector side, of the negative electrode tab.

According to this configuration, since “sN sEn” is satisfied, the material including the negative electrode side solid electrolyte layer is easily transferred onto the material including the negative electrode with the material including the negative electrode as a base.

Moreover, since “sF≥sEc≥sEn” is satisfied, any of the predetermined solid electrolyte layer and the negative electrode side solid electrolyte layer is less likely to protrude outward of the positive electrode frame. Thus, the susceptibility of the solid electrolyte layer to damage can be reduced in a process of manufacturing the solid-state battery.

In addition, the insulating member is attached to a surface, on the positive electrode current collector side, of the negative electrode tab. With the insulating member, an insulation distance between the negative electrode tab and the positive electrode current collector is easily ensured.

According to the configuration above, a long insulation distance between a positive electrode side conductor and a negative electrode side conductor can be easily ensured while making the solid electrolyte layer less susceptible to damage.

(2) The solid-state battery according to (1), which further includes an intermediate layer between the negative electrode side solid electrolyte layer and the negative electrode, and when the area of the intermediate layer is defined as “sM”, a relationship “sN≥sM≥sEn” is satisfied.

According to this configuration, the intermediate layer has a predetermined role so that the performance of the solid-state battery can be further improved. Since “sN≥sM” is satisfied, the material including the intermediate layer is easily transferred onto the material including the negative electrode with the material including the negative electrode as a base. Moreover, since “sN≥sM” is satisfied, an insulation distance between the intermediate layer and the positive electrode side conductor is also easily ensured in a case where the intermediate layer forms the negative electrode side conductor. Further, since “sM≥sEn” is satisfied, the material including the negative electrode side solid electrolyte layer is easily transferred onto the material including the intermediate layer with the material including the intermediate layer as a base.

(2) The solid-state battery according to (1) or (2), which further includes a positive electrode side solid electrolyte layer between the positive electrode material layer and the predetermined solid electrolyte layer, and when the area of the positive electrode side solid electrolyte layer in the plan view is defined as “sEp”, a relationship “sF≥sEc≥sEp” is satisfied.

According to this configuration, since “sF≥sEp” is satisfied, the material including the positive electrode side solid electrolyte layer is easily transferred onto the material including the positive electrode frame with the material including the positive electrode frame as a base. Moreover, since “sEc≥sEp” is satisfied, the material including the positive electrode side solid electrolyte layer is easily transferred onto the material including the predetermined solid electrolyte layer.

(4) The solid-state battery according to any one of (1) to (3), which further includes a positive electrode tab insulator protruding from the positive electrode frame in a protruding direction of the positive electrode tab, and the positive electrode tab insulator protrudes in the protruding direction of the positive electrode tab as compared to the predetermined solid electrolyte layer.

According to this configuration, the positive electrode tab insulator can ensure a longer insulation distance between the positive electrode tab and the negative electrode.

(5) The solid-state battery according to any one of (1) to (4), which further includes a positive electrode side solid electrolyte layer between the positive electrode material layer and the predetermined solid electrolyte layer, and an intermediate layer between the negative electrode side solid electrolyte layer and the negative electrode, and when the area of the positive electrode material layer in the plan view is defined as “sPm”,
the area of the positive electrode side solid electrolyte layer in the plan view is defined as “sEp”, and
the area of the intermediate layer in the plan view is defined as “sM”,
a relationship “sF≥sEc≥sEp≥sN≥sM≥sEn≥sPm” is satisfied.

According to this configuration, since “sF≥sEp” is satisfied, the positive electrode side solid electrolyte layer is easily transferred onto the positive electrode frame and the positive electrode material layer with the positive electrode frame side as a base. Since “sN≥sM” is satisfied, the material including the intermediate layer is easily transferred onto the material including the negative electrode with the material including the negative electrode as a base. Since “sM≥sEn” is satisfied, the material including the negative electrode side solid electrolyte layer is easily transferred onto the material including the intermediate layer with the material including the intermediate layer as a base. Since “sEc≥sEp” is satisfied, the material including the positive electrode side solid electrolyte layer is easily transferred onto the material including the predetermined solid electrolyte layer. Since “sEc≥sEn” is satisfied, the material including the negative electrode side solid electrolyte layer is easily transferred onto the material including the predetermined solid electrolyte layer.

(6) The solid-state battery according to any one of (1) to (5), in which the negative electrode includes a negative electrode current collector and a negative electrode material layer that is provided closer to the positive electrode current collector than the negative electrode current collector and contains metal lithium.

According to this configuration, the above-described effects can be obtained in such a solid-state battery.

(7) A method for manufacturing a solid-state battery including a positive electrode current collector, a positive electrode material layer, a predetermined solid electrolyte layer, a negative electrode side solid electrolyte layer, and a negative electrode in this order towards at least one side in a lamination direction, a positive electrode tab protruding from the positive electrode current collector, and a negative electrode tab protruding from the negative electrode, and being configured such that an insulating positive electrode frame surrounding the positive electrode material layer is provided closer to the negative electrode than the positive electrode current collector,
the volume of the negative electrode increases by charging, and decreases by discharging,
when the area of a portion inside the outer edge of the positive electrode frame in a plan view in the lamination direction is defined as “sF”, the area of the predetermined solid electrolyte layer in the plan view is defined as “sEc”, the area of the negative electrode side solid electrolyte layer in the plan view is defined as “sEn”, and the area of the negative electrode in the plan view is defined as “sN”, a relationship “sF≥sEc≥sN≥sEn” is satisfied, and
an insulating member is attached to a surface, on the positive electrode current collector side, of the negative electrode tab
the method including:
transferring the negative electrode side solid electrolyte layer onto the predetermined solid electrolyte layer by roll pressing.

According to this manufacturing method, effects similar to those in the case of the solid-state battery according to (1) are also produced. In addition, as described above, the negative effect that the solid electrolyte layer is easily damaged when it protrudes outward is most prominent in a case where the solid-state battery is manufactured by roll pressing. In this method, the solid-state battery is manufactured by roll pressing. According to this method, the effect of reducing the susceptibility of the solid electrolyte layer to damage as in (1) above can be more prominently produced.

As described above, according to the solid-state battery of (1) above and the solid-state battery manufacturing method of (7) above, a long insulation distance between the negative electrode tab and the positive electrode current collector can be easily ensured while making the solid electrolyte layer less susceptible to damage. Further, according to the configurations of (2) to (6) citing (1), additional effects are produced.

### BRIEF DESCRIPTION OF THE DRAWINGS

FIG. 1 is an exploded perspective view showing each layer of a solid-state battery of a first embodiment;

FIG. 2 is a plan view showing the solid-state battery;

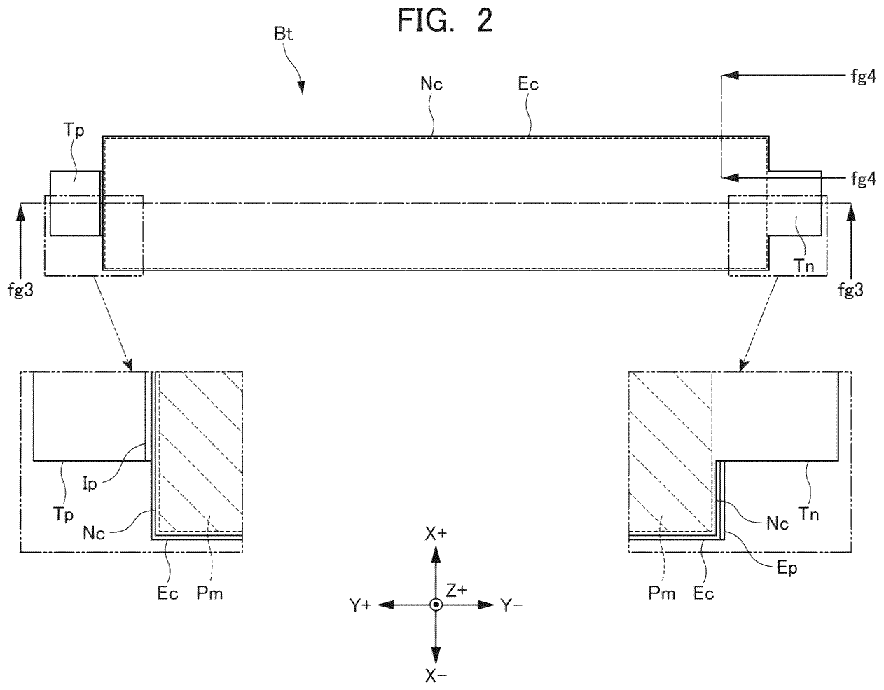

FIG. 3 is a sectional view taken along a fg3-fg3 line in FIG. 2;

FIG. 4 is a sectional view taken along a fg4-fg4 line in FIG. 2;

FIG. 5 is a perspective view showing the first half of a negative electrode side manufacturing step;

FIG. 6 is a perspective view showing the second half of the negative electrode side manufacturing step; and

FIG. 7 is a perspective view showing a positive electrode side manufacturing step and a whole manufacturing step.

### DETAILED DESCRIPTION OF THE INVENTION

Hereinafter, embodiments of the present invention will be descried with reference to the drawings. Note that the present invention is not limited to the embodiments below and changes can be made as necessary without departing from the gist of the present invention.

### First Embodiment

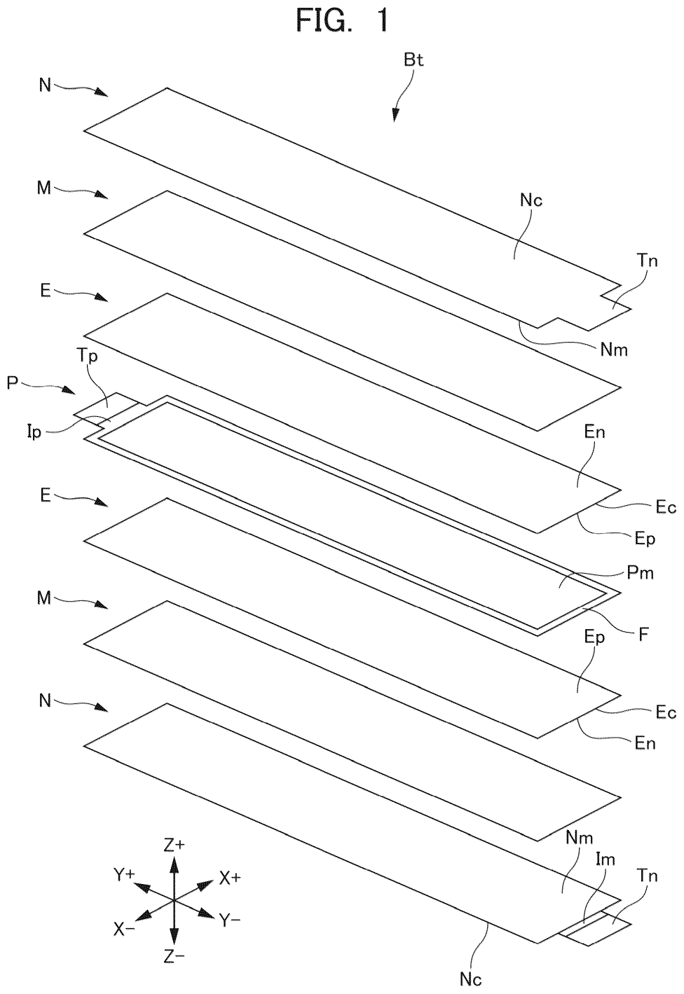

A solid-state battery Bt of the present embodiment shown in FIG. 1 is a lithium-metal secondary battery, and includes a plurality of layers. Hereinafter, three directions perpendicular to each other will be referred to as an “X direction”, a “Y direction”, and a “Z direction”. Note that the “Z direction” may be read as a lamination direction.

Hereinafter, one side in the X direction will be referred to as an “X− side”, and the opposite side thereof will be referred to as an “X+ side”. Moreover, one side in the Y direction will be referred to as a “Y− side”, and the other side in the Y direction will be referred to as a “Y+ side”. Further, one side in the Z direction will be referred to as a “Z− side”, and the opposite side thereof will be referred to as a “Z+ side”.

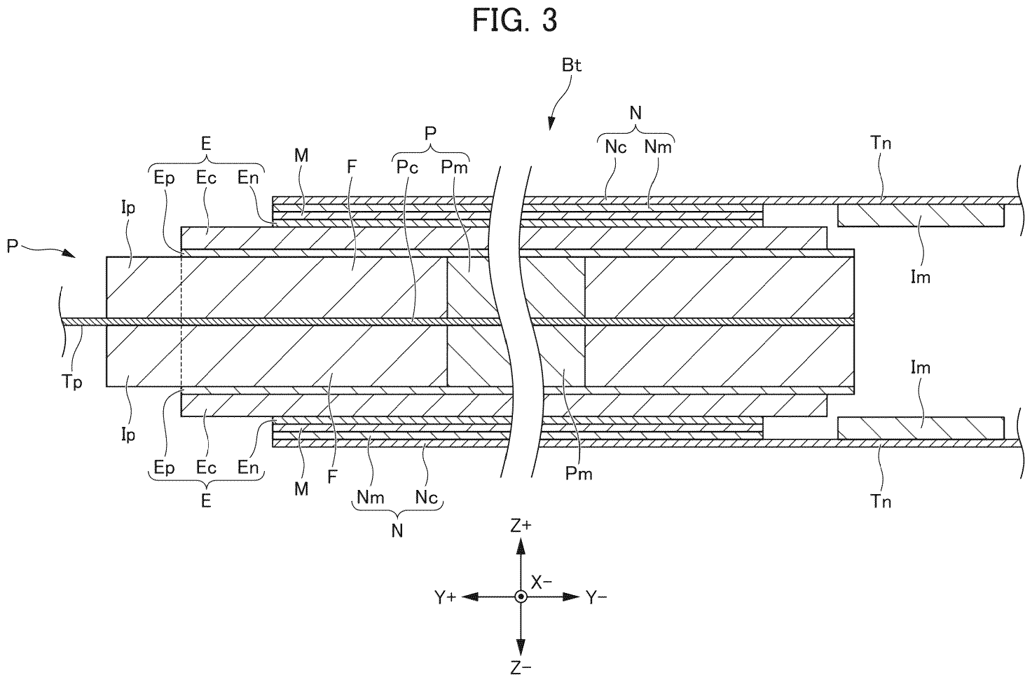

As shown in FIG. 3, the solid-state battery Bt includes a positive electrode current collector Pc, and in the order from the positive electrode current collector Pc towards each of the Z+ side and the Z− side, includes a positive electrode material layer Pm, a positive electrode side electrolyte layer Ep, an intermediate electrolyte layer Ec, a negative electrode side electrolyte layer En, an intermediate layer M, a negative electrode material layer Nm, and a negative electrode current collector Nc. Further, the solid-state battery Bt includes, on each of the Z+ side and the Z− side of the positive electrode current collector Pc, an insulating positive electrode frame F surrounding the positive electrode material layer Pm.

The positive electrode current collector Pc and the positive electrode material layer Pm form a positive electrode P. The positive electrode side electrolyte layer Ep, the intermediate electrolyte layer Ec, and the negative electrode side electrolyte layer En form a solid electrolyte layer E. Note that the “positive electrode side electrolyte layer Ep”, the “intermediate electrolyte layer Ec”, and the “negative electrode side electrolyte layer En” may be read as a “positive electrode side solid electrolyte layer”, a “predetermined solid electrolyte layer”, and a “negative electrode side solid electrolyte layer”, respectively. The negative electrode material layer Nm and the negative electrode current collector Nc form a negative electrode N.

Hereinafter, a plan view in the Z direction will be merely referred to as a “plan view”. Moreover, hereinafter, the area of a portion inside the outer edge of the positive electrode frame F in the plan view will be defined as “sF”. The area of the positive electrode material layer Pm in the plan view will be defined as “sPm”. The area of the positive electrode side electrolyte layer Ep in the plan view will be defined as “sEp”. The area of the intermediate electrolyte layer Ec in the plan view will be defined as “sEc”. The area of the negative electrode side solid electrolyte layer En in the plan view will be defined as “sEn”. The area of the intermediate layer M in the plan view will be defined as “sM”. The area of the negative electrode N in the plan view will be defined as “sN”. Thus, “sN” is the area of a portion including the negative electrode material layer Nm and the negative electrode current collector Nc in the plan view. Note that in the present embodiment, the area of the negative electrode current collector Nc is the area of the negative electrode material layer Nm or more in the plan view, and therefore, “sN” is substantially the area of the negative electrode current collector Nc in the plan view.

The solid-state battery Bt further includes a positive electrode tab Tp protruding from the positive electrode current collector Pc to the Y+ side. Thus, the “Y+ side” may be read as a “protruding direction of the positive electrode tab Tp”. Note that the positive electrode P and the positive electrode tab Tp form a positive electrode P side conductor. The solid-state battery Bt further includes a positive electrode tab insulator Ip protruding from the positive electrode frame F to the Y+ side. Note that the area of the positive electrode tab insulator Ip is not included in “SF”. The solid-state battery Bt further includes a negative electrode tab Tn protruding from the negative electrode current collector Nc to the Y− side. Thus, the “Y− side” may be read as a “protruding direction of the negative electrode tab Tn”. Note that the area of the negative electrode tab Tn is not included in “sN”. The intermediate layer M, the negative electrode N, and the negative electrode tab Tn form a negative electrode N side conductor. An insulating member Im is attached to a portion of the negative electrode tab Tn close to the base end thereof, i.e., a surface, on the positive electrode P side, of a portion of the negative electrode tab Tn close to the Y− side.

Next, details of each layer of the solid-state battery Bt will be described in the order from the positive electrode P side.

A specific example of a material forming the positive electrode current collector Pc includes aluminum foil. The positive electrode tab Tp is formed integrally with the positive electrode current collector Pc.

The positive electrode material layer Pm contains a positive electrode active material as a material capable of adsorbing and desorbing lithium. Specific examples of the positive electrode active material include LiCoO₂, Li(Ni_{5/10}Co_{2/10}Mn_{3/10})O₂, Li(Ni_{6/10}Co_{2/10}Mn_{2/10})O₂, Li(Ni_{5/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, and sulfur. The positive electrode material layer Pm may further contain, for example, a solid electrolyte, a conductive auxiliary agent, and a binding agent. The positive electrode material layer Pm is located inside the positive electrode frame F. Thus, among “sPm”, “sF”, “sEp”, “sEc”, “sEn”, “sM”, and “sN”, “sPm” is the smallest.

As shown in FIG. 1, the positive electrode frame F is a quadrangular frame shape in the plan view. Specific examples of a material forming the positive electrode frame F include an insulating oxide such as alumina, a resin such as polyvinylidene fluoride (PVDF), and a rubber such as styrene-butadiene rubber (SBR). The positive electrode tab insulator Ip is formed integrally with the positive electrode frame F.

The solid electrolyte layer E shown in FIG. 3 contains a solid electrolyte capable of conducting lithium ions.

Specific examples of the solid electrolyte include an oxide-based electrolyte and a sulfide-based electrolyte. The solid electrolyte layer E contains a binder.

The positive electrode side electrolyte layer Ep is transferred onto the positive electrode material layer Pm and the positive electrode frame F with the positive electrode P side as a base. Thus, a relationship “sF≥sEp” is satisfied. Thereafter, the positive electrode side electrolyte layer Ep is transferred onto the intermediate electrolyte layer Ec. Thus, a relationship “sEc≥sEp” is also satisfied.

The intermediate electrolyte layer Ec is a main layer of the solid electrolyte layer E, and is thicker in the Z direction than any of the positive electrode side electrolyte layer Ep and the negative electrode side electrolyte layer En. The intermediate electrolyte layer Ec contains a porous base material such as non-woven fabric and the above-described solid electrolyte with which the base material is filled. The content of the binder in the intermediate electrolyte layer Ec is different from the content of a binder in the negative electrode side solid electrolyte layer En. In the present embodiment, a relationship “sF≥sEc” is satisfied such that the intermediate electrolyte layer Ec is less likely to protrude outward of the positive electrode frame F.

The negative electrode side electrolyte layer En is transferred onto the intermediate layer M with the intermediate layer M side as a base. Thus, a relationship “sM≥sEn” is satisfied. Thereafter, the negative electrode side electrolyte layer En is transferred onto the intermediate electrolyte layer Ec. Thus, a relationship “sEc≥sEn” is also satisfied.

A specific example of a material forming the intermediate layer M includes carbon supporting a metal (e.g., silver) which can be alloyed with lithium. With the intermediate layer M, an interface between the solid electrolyte layer E and the intermediate layer M is stabilized, and an interface between the intermediate layer M and the negative electrode material layer Nm is stabilized. Further, the intermediate layer M has a function of uniformly precipitating lithium metal. The intermediate layer M is transferred onto the negative electrode material layer Nm with the negative electrode N side as a base. Thus, a relationship “sN≥sM” is satisfied. Since “sN≥sM” is satisfied, an insulation distance between the intermediate layer M and the positive electrode P side conductor is easily ensured.

The negative electrode material layer Nm contains a negative electrode active material as a material capable of adsorbing and desorbing a lithium ion. Specific examples of the negative electrode active material include metal lithium, lithium alloy, metal oxide, metal sulfide, metal nitride, Si, SiO, and a carbon material. The carbon material includes, for example, artificial graphite, natural graphite, hard carbon, and soft carbon. The negative electrode material layer Nm may further contain, for example, a solid electrolyte, a conductive auxiliary agent, and a binding agent. Thus, the negative electrode material layer Nm may be a layer mainly containing metal lithium or a layer mainly containing silicon.

A specific example of a material forming the negative electrode current collector Nc includes copper foil. The negative electrode tab Tn is formed integrally with the negative electrode current collector Nc.

A specific example of the material of the insulating member Im includes polyimide. The insulating member Im may be, for example, an insulating tape or a resin-applied portion made of resin applied to the negative electrode tab Tn. As shown in FIG. 1, the insulating member Im extends from the X-side end of the negative electrode tab Tn to the X+ side end of the negative electrode tab Tn. Thus, the length of the insulating member Im in the X direction is the same as the width of the negative electrode tab Tn in the X direction.

With the above-described configuration, a relationship “sF≥sEc≥sEp≥sN≥sM≥sEn≥sPm” is satisfied in the present embodiment.

Next, a positional relationship among the Y+ side ends of the layers of the solid-state battery Bt will be described with reference to a portion on the left side in FIG. 3. Each of the negative electrode side electrolyte layer En, the intermediate layer M, the negative electrode material layer Nm, and the negative electrode current collector Nc protrudes to the Y+ side as compared to the positive electrode material layer Pm. Each of the positive electrode current collector Pc, the positive electrode frame F, the positive electrode side electrolyte layer Ep, and the intermediate electrolyte layer Ec protrudes to the Y+ side as compared to any of these layers En, M, Nm, Nc. The positive electrode tab insulator Ip protrudes to the Y+ side as compared to any of these layers Pc, F, Ep, Ec. The positive electrode tab Tp protrudes to the Y+ side as compared to the positive electrode tab insulator Ip. Note that the protruding length of the positive electrode tab insulator Ip to the Y+ side from the intermediate electrolyte layer Ec is about 0.5 to 1.0 mm.

Next, a positional relationship among the Y− side ends of the layers of the solid-state battery Bt will be described with reference to a portion on the right side in FIG. 3. Each of the negative electrode side electrolyte layer En, the intermediate layer M, the negative electrode material layer Nm, and the negative electrode current collector Nc protrudes to the Y− side as compared to the positive electrode material layer Pm. The intermediate electrolyte layer Ec protrudes to the Y− side as compared to any of these layers En, M, Nm, Nc. Each of the positive electrode side electrolyte layer Ep, the positive electrode frame F, and the positive electrode current collector Pc protrudes to the Y− side as compared to the intermediate electrolyte layer Ec.

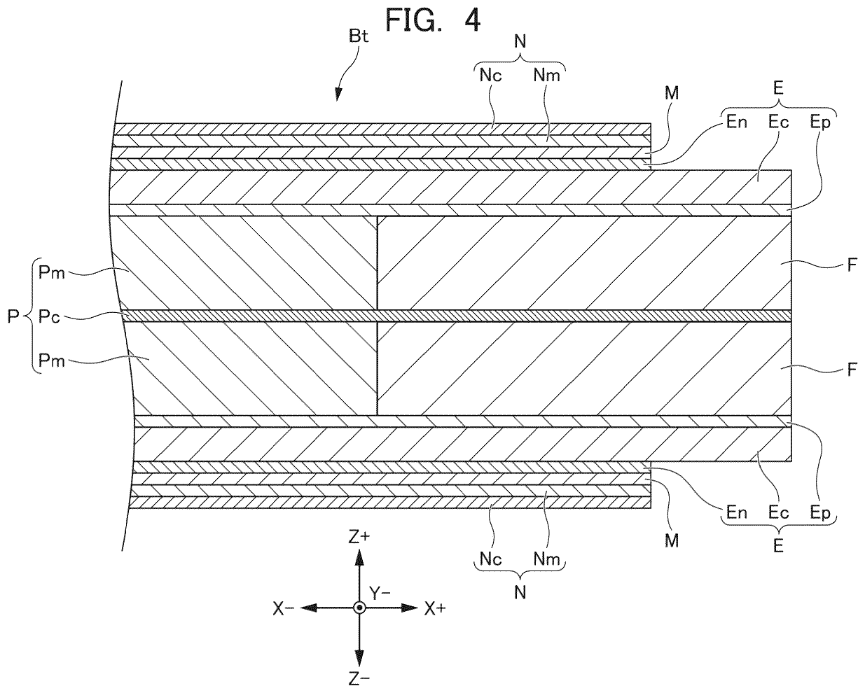

Next, a positional relationship among the ends of the layers of the solid-state battery Bt in the X direction will be described with reference to FIG. 4. Note that FIG. 4 shows only the X+ side ends of the layers of the solid-state battery Bt and does not show the X− side ends, but the X− side ends are similar to when the X+ side ends shown in FIG. 4 are inverted with respect to the Z direction.

Each of the intermediate layer M, the negative electrode side electrolyte layer En, the negative electrode current collector Nc, and the negative electrode material layer Nm protrudes outward in the X direction as compared to the positive electrode material layer Pm. Each of the positive electrode current collector Pc, the positive electrode frame F, the positive electrode side electrolyte layer Ep, and the intermediate electrolyte layer Ec protrudes outward in the X direction as compared to any of these layers M, En, Nc, Nm.

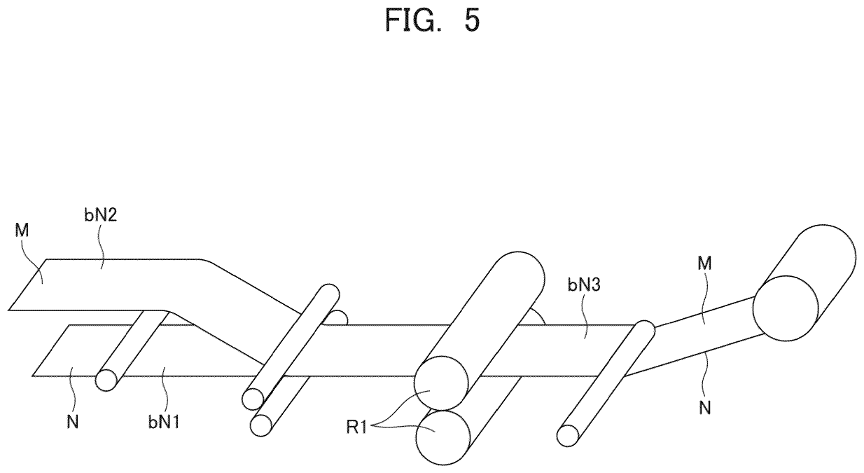

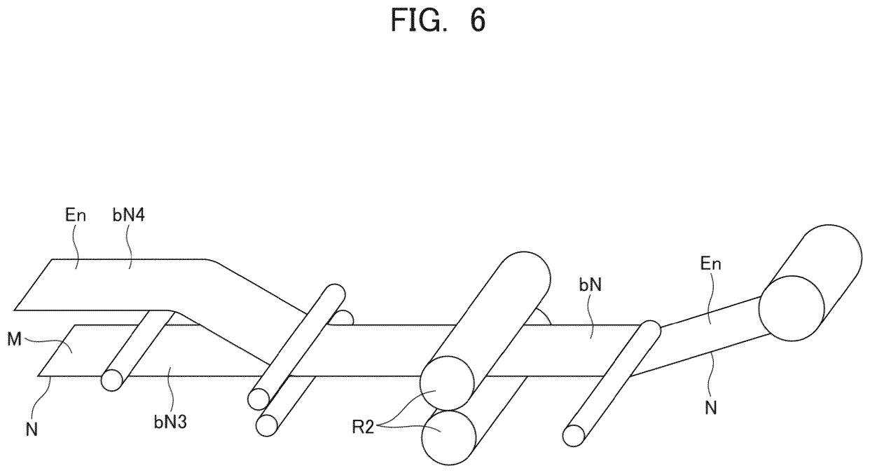

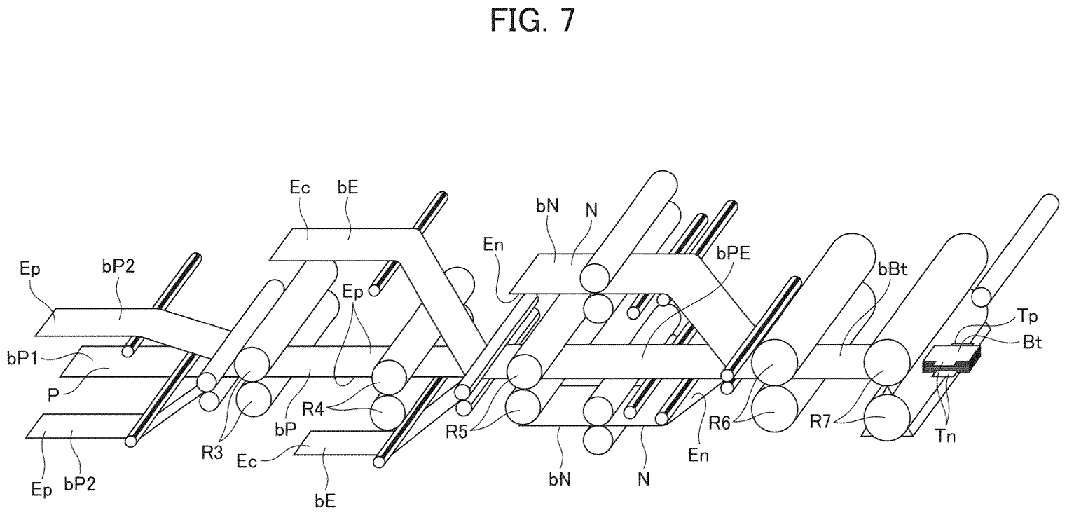

Next, a method for manufacturing the solid-state battery Bt described above will be described. The manufacturing method includes a negative electrode side manufacturing step shown in FIGS. 5 and 6 and a positive electrode side manufacturing step and a whole manufacturing step shown in FIG. 7. Any of the negative electrode side manufacturing step and the positive electrode side manufacturing step may be performed first, or these steps may be performed in parallel. On the other hand, the whole manufacturing step is performed after the negative electrode side manufacturing step and the positive electrode side manufacturing step.

First, the negative electrode side manufacturing step will be described. In the negative electrode side manufacturing step, a negative electrode side first band bN1 and a negative electrode side second band bN2 are first prepared as shown in FIG. 5. The negative electrode side first band bN1 is a material continuously including negative electrodes N, negative electrode tabs Tn, and insulating members Im in the X direction. On the other hand, the negative electrode side second band bN2 is a material continuously including an intermediate layer M in the X direction. Next, the negative electrode side second band bN2 is transferred onto the negative electrode side first band bN1 by roll pressing with first rollers R1, and in this manner, a negative electrode side third band bN3 is manufactured.

Next, as shown in FIG. 6, a negative electrode side fourth band bN4 is prepared. The negative electrode side fourth band bN4 is a material continuously including a negative electrode side electrolyte layer En in the X direction. Next, the negative electrode side fourth band bN4 is transferred onto the negative electrode side third band bN3 by roll pressing with second rollers R2, and in this manner, a negative electrode side band bN is manufactured.

Next, the positive electrode side manufacturing step will be described with reference to a portion on the left side in FIG. 7. In the positive electrode side manufacturing step, a positive electrode side first band bP1 and a positive electrode side second band bP2 are prepared. The positive electrode side first band bP1 is a material formed such that positive electrodes P, positive electrode tabs Tp, positive electrode frames F, and positive electrode tab insulators Ip are arranged in the X direction. On the other hand, the positive electrode side second band bP2 is a material continuously including a positive electrode side solid electrolyte layer Ep in the X direction. Next, the positive electrode side second bands bP2 are transferred onto both sides of the positive electrode side first band bP1 in the Z direction by roll pressing with third rollers R3, and in this manner, a positive electrode side band bP is manufactured. Next, the positive electrode side band bP is further pressed with fourth rollers R4, and in this manner, the density thereof is increased.

Next, the whole manufacturing step will be described with reference to a portion on the right side in FIG. 7. In the whole manufacturing step, an electrolyte side band bE is first prepared. The electrolyte side band bE is a material continuously including an intermediate electrolyte layer Ec in the X direction. Next, the electrolyte side bands bE are transferred onto both sides of the positive electrode side band bP in the Z direction by roll pressing, and in this manner, a positive electrode-electrolyte side band bPE is manufactured. Next, the negative electrode side bands bN are transferred onto both sides of the positive electrode-electrolyte side band bPE in the Z direction by roll pressing with sixth rollers R6, and in this manner, a solid-state battery band bBt is manufactured. Next, the solid-state battery band bBt is cut with rotary cutters R7 at a predetermined location in the X direction while the positive electrode tab Tp and the negative electrode tab Tn are machined. In this manner, the solid-state battery Bt is manufactured.

The internal structure of the solid-state battery Bt manufactured as described above is stored in a state where it is pressed inward in the Z direction such that the layers adjacent to each other in the Z direction are in close contact with each other. Thus, upon use, the solid-state battery Bt is in such a state that the positive electrode P is constantly pressed to the negative electrode N side and the negative electrode N is constantly pressed to the positive electrode P side.

In the state upon use, the solid-state battery Bt is repeatedly charged and discharged between a predetermined fully-charged state and a predetermined fully-discharged state. As the solid-state battery Bt is charged, the negative electrode material layer Nm adsorbs lithium and the volume of the negative electrode N increases. On the other hand, as the solid-state battery Bt is discharged, the negative electrode material layer Nm desorbs lithium, and the volume of the negative electrode N decreases.

Hereinafter, a value obtained by dividing the volume of the negative electrode N in the fully-charged state of the solid-state battery Bt by the volume of the negative electrode N in the fully-discharged state will be defined as a “negative electrode expansion ratio”. In the present embodiment, the negative electrode expansion ratio is about 2.5 times or more and 4.0 times or less. Note that the negative electrode expansion ratio may be changed as necessary, for example, within a range of 1.8 times or more and 5.5 times or less.

The configuration and effects of the present embodiment will be summarized below.

The relationship “sF≥sEc≥sEp≥sN≥sM≥sEn≥sPm” is satisfied. Since “sF≥sEp” is satisfied, the band including the positive electrode side electrolyte layer Ep is easily transferred onto the band including the positive electrode frame F and the positive electrode material layer Pm with the band including the positive electrode frame F as the base. Since “sN≥sM” is satisfied, the band including the intermediate layer M is easily transferred onto the band including the negative electrode N with the band including the negative electrode N as the base. Since “sM≥sEn” is satisfied, the band including the negative electrode side electrolyte layer En is easily transferred onto the band including the intermediate layer M with the band including the intermediate layer M as the base. Since “sEc>sEp” is satisfied, the band including the positive electrode side electrolyte layer Ep is easily transferred onto the band including the intermediate electrolyte layer Ec. Since “sEc>sEn” is satisfied, the band including the negative electrode side electrolyte layer En is easily transferred onto the band including the intermediate electrolyte layer Ec.

Since “sF≥sEc≥sEp sEn” is satisfied, any of the positive electrode side electrolyte layer Ep, the intermediate electrolyte layer Ec, and the negative electrode side electrolyte layer En is less likely to protrude outward of the positive electrode frame F. That is, the solid electrolyte layer E is less likely to protrude outward of the positive electrode frame F. Thus, the solid electrolyte layer E is less susceptible to damage in a process of manufacturing the solid-state battery Bt.

In addition, the insulating member Im is attached to a surface, on the positive electrode P side, of the negative electrode tab Tn. With the insulating member Im, an insulation distance between the negative electrode tab Tn and the positive electrode current collector Pc is easily ensured.

The positive electrode tab insulator Ip protrudes to the Y+ side as compared to the intermediate electrolyte layer Ec. With The positive electrode tab insulator Ip, a longer insulation distance between the positive electrode tab Tp and the negative electrode N can be ensured.

A negative effect that the solid electrolyte layer E is easily damaged when it protrudes outward is most prominent in a case where the solid-state battery Bt is manufactured by roll pressing. In the present embodiment, the solid-state battery Bt is manufactured by roll pressing. According to the present embodiment, the above-described effect of reducing the susceptibility of the solid electrolyte layer E to damage can be more prominently produced.

### Other Embodiments

The above-described embodiment can be changed as follows, for example. In the first embodiment, the positive electrode tab Tp and the negative electrode tab Tn protrude in the opposite directions, but instead, may protrude in the same direction. In a case where the intermediate electrolyte layer Ec can be transferred onto the positive electrode P without the positive electrode side electrolyte layer Ep, the positive electrode side electrolyte layer Ep may be omitted.

The negative electrode N may be an anode-free electrode including no negative electrode material layer Nm immediately after manufactured. In this case, after initial charging, a lithium metal layer is formed as the negative electrode material layer Nm. The solid-state battery Bt may be a battery other than the lithium-metal secondary battery. In this case, the intermediate layer M for uniformly precipitating lithium metal may be omitted.

### EXPLANATION OF REFERENCE NUMERALS

Bt Solid-State Battery
Ec Intermediate Electrolyte Layer (Predetermined Solid
Electrolyte Layer)
En Negative Electrode Side Electrolyte Layer (Negative Electrode Side Solid Electrolyte Layer)
Ep Positive Electrode Side Electrolyte Layer (Positive
Electrode Side Solid Electrolyte Layer)
F Positive Electrode Frame
Im Insulating Member
Ip Positive Electrode Tab Insulator
M Intermediate Layer
N Negative Electrode
Nc Negative Electrode Current Collector
Nm Negative Electrode Material Layer
P Positive Electrode
Pc Positive Electrode Current Collector
Pm Positive Electrode Material Layer
Tn Negative Electrode Tab
Tp Positive Electrode Tab

What is claimed is:

1. A solid-state battery comprising:
a positive electrode current collector, a positive electrode material layer, a predetermined solid electrolyte layer, a negative electrode side solid electrolyte layer, and a negative electrode in this order towards at least one side in a lamination direction; a positive electrode tab protruding from the positive electrode current collector; and a negative electrode tab protruding from the negative electrode,
wherein, an insulating positive electrode frame is provided closer to the negative electrode than the positive electrode current collector so as to surround the positive electrode material layer,
a volume of the negative electrode increases by charging, and decreases by discharging,
when an area of a portion inside an outer edge of the positive electrode frame in a plan view in the lamination direction is defined as “sF”, an area of the predetermined solid electrolyte layer in the plan view is defined as “sEc”, an area of the negative electrode side solid electrolyte layer in the plan view is defined as “sEn”, and an area of the negative electrode in the plan view is defined as “sN”,
a relationship “sF≥sEc≥sN≥sEn” is satisfied, and
an insulating member is attached to a surface, on positive electrode current collector side, of the negative electrode tab.

2. The solid-state battery according to claim 1, further comprising:
an intermediate layer between the negative electrode side solid electrolyte layer and the negative electrode,
wherein when an area of the intermediate layer is defined as “sM”,
a relationship “sN≥sM≥sEn” is satisfied.

3. The solid-state battery according to claim 1, further comprising:
a positive electrode side solid electrolyte layer between the positive electrode material layer and the predetermined solid electrolyte layer,
wherein when an area of the positive electrode side solid electrolyte layer in the plan view is defined as “sEp”,
a relationship “sF≥sEc≥sEp” is satisfied.

4. The solid-state battery according to claim 1, further comprising:
a positive electrode tab insulator protruding from the positive electrode frame in a protruding direction of the positive electrode tab,
wherein the positive electrode tab insulator protrudes in the protruding direction of the positive electrode tab as compared to the predetermined solid electrolyte layer.

5. The solid-state battery according to claim 1, further comprising:
a positive electrode side solid electrolyte layer between the positive electrode material layer and the predetermined solid electrolyte layer; and
an intermediate layer between the negative electrode side solid electrolyte layer and the negative electrode,
wherein when an area of the positive electrode material layer in the plan view is defined as “sPm”,
an area of the positive electrode side solid electrolyte layer in the plan view is defined as “sEp”, and
an area of the intermediate layer in the plan view is defined as “sM”,
a relationship “sF≥sEc≥sEp≥sN≥sM≥sEn≥sPm” is satisfied.

6. The solid-state battery according to claim 1, wherein
the negative electrode includes a negative electrode current collector and a negative electrode material layer that is provided closer to the positive electrode current collector than the negative electrode current collector and contains metal lithium.

7. A method for manufacturing a solid-state battery including a positive electrode current collector, a positive electrode material layer, a predetermined solid electrolyte layer, a negative electrode side solid electrolyte layer, and a negative electrode in this order towards at least one side in a lamination direction, a positive electrode tab protruding from the positive electrode current collector, and a negative electrode tab protruding from the negative electrode, and
being configured such that an insulating positive electrode frame is provided closer to the negative electrode than the positive electrode current collector so as to surround the positive electrode material layer,
a volume of the negative electrode increases by charging, and decreases by discharging,
when an area of a portion inside an outer edge of the positive electrode frame in a plan view in the lamination direction is defined as “sF”, an area of the predetermined solid electrolyte layer in the plan view is defined as “sEc”, an area of the negative electrode side solid electrolyte layer in the plan view is defined as “sEn”, and an area of the negative electrode in the plan view is defined as “sN”,
a relationship “sF≥sEc≥sN≥sEn” is satisfied, and
an insulating member is attached to a surface, on positive electrode current collector side, of the negative electrode tab,
the method comprising:
transferring the negative electrode side solid electrolyte layer onto the predetermined solid electrolyte layer by roll pressing.
